(19) United States
(12) Patent Application Publication
(10) Pub. No.: US 2007/0027984 A1
(43) Pub. Date: Feb. 1, 2007

(54) Monitoring of network packets

(76) Inventors: Steven Glen Jorgensen, Newcastle, CA (US); Jonathan Edward Greenlaw, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/192,835

(22) Filed: Jul. 29, 2005

(51) Int. Cl. G06F 15/173

(52) U.S. Cl. 709/224

(57) ABSTRACT

One embodiment disclosed relates to a method of monitoring network traffic. A network data packet is received. Network address information is extracted from the network data packet, and a data value is created therefrom. The data value is compared with a set of predetermined network address information. If a match is found, a determination is made whether said network data packet is to be mirrored based on a preselected sampling technique. Other embodiments are also disclosed.

### BACKGROUND OF THE INVENTION

1. Field of the Invention

The present invention relates generally to networking and communications technology.

2. Description of the Background Art

Network traffic mirroring (or monitoring) is a process by which network traffic is sent to a mirror (or monitor) port or interface, in addition to the intended destination of the traffic. A network monitoring device or network analyzer may be attached to the mirror port/interface to detect problems in the network.

Conventional mirroring logic does not anticipate the port speed or capacity of the monitoring device. As such, the mirroring device may send more packets to the monitoring device than the monitoring device can handle. When the input buffer of the monitoring device overflows, the monitoring device may drop packets without regard to their importance or ordering. This may cause the monitoring device to obtain poorly distributed subsets of the data traffic that it wants to monitor.

It is desirable to improve networking and communications technology. In particular, it is desirable to improve apparatus and methods of mirroring or monitoring network traffic.

### BRIEF DESCRIPTION OF THE DRAWINGS

FIG. 1 is a schematic diagram illustrating a networking switch in accordance with an embodiment of the invention.

FIG. 2 is a diagram illustrating a CAM configuration.

FIG. 3 is a flow chart depicting a method of monitoring network traffic in accordance with an embodiment of the invention.

FIG. 4 is a flow chart depicting a method of monitoring application-specific traffic in accordance with an embodiment of the invention.

FIG. 5 is a flow chart depicting a method of monitoring traffic between a pair of networks in accordance with an embodiment of the invention.

FIG. 6 is a diagram depicting fields of a conventional IP header.

### DETAILED DESCRIPTION

By mirroring a portion of network traffic, a network administrator may obtain a very accurate view over time of an aspect of a network being monitored. However, the view may be obscured and hindered by an overload of data that overflows the monitoring system such that the monitored traffic is poorly distributed and not representative.

To limit the mirrored traffic, sampling logic has been used. Previous implementations of sampling logic have generally been port-based or backplane-based. However, as port speeds and port densities increase, the number of samples in a small sampling window (for example, a window of one second) increases to a point that there are too many packets being mirrored to a monitoring device. Receiving too many packets to handle, the monitoring device becomes overwhelmed.

The present disclosure provides a technique where sampling of network packets is performed based on Internet Protocol (IP) addresses. This technique enables the mirrored traffic to be limited and tailored advantageously relative to prior sampling techniques. For example, the IP address based sampling technique disclosed herein may be advantageously applied to avoid the above discussed monitoring system overloads by providing a smaller subset of well-distributed data to be monitored.

Another problem with previous sampling logic is that large numbers of uninteresting samples may be generated. In contrast, the IP address based sampling technique disclosed herein may be advantageously applied such that only packets of interest are sent to the monitoring device.

Another problem relating to port-based sampling is that port-based sampling cannot deal effectively with the case where a single stream might enter different ports. In contrast, the IP address based sampling technique disclosed herein may be advantageously applied to sample such a single stream even if it arrives via multiple ports.

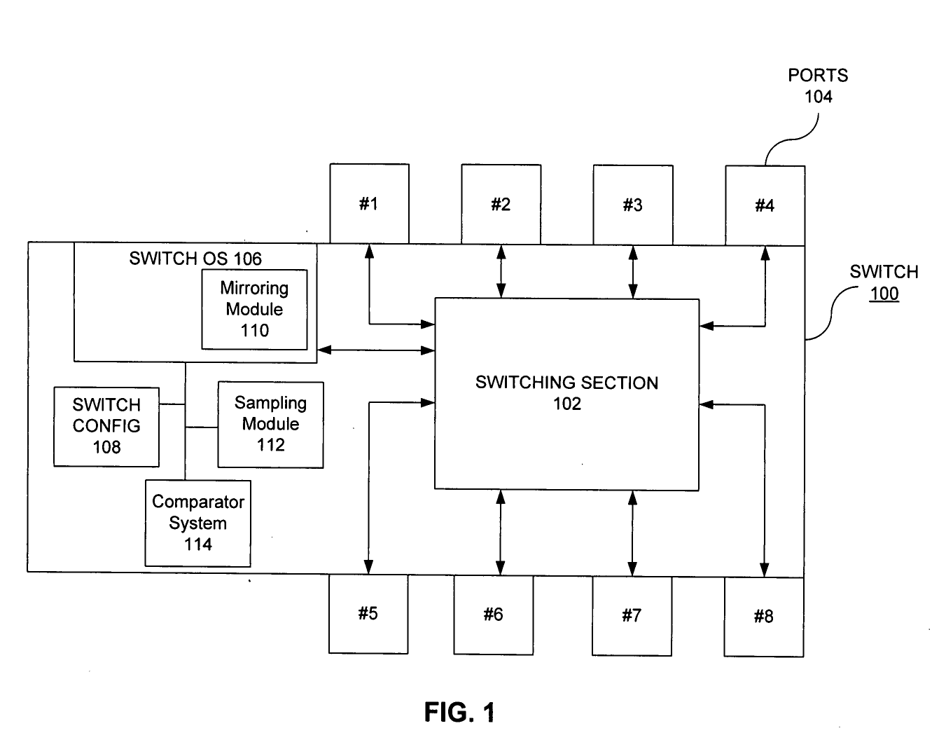

FIG. 1 is a schematic diagram illustrating a networking switch in accordance with an embodiment of the invention. The switch 100 includes a switching section 102, a plurality of switch ports 104, a switch operating system (OS) 106, a switch configuration 108, and a mirroring engine 110.

The switching section 102 is coupled to each of the ports 104. The switching section may include, for example, a switching core such as a crossbar switch or other circuitry, and makes connections between the ports 104 so that data frames can be transferred from one port to another port. Eight switch ports 104 are shown in this example. The ports 104 are shown as numbered, for example, as #1, #2, #3, #4, #5, #6, #7, and #8. Of course, other implementations may include any number of ports.

The switch OS 106 includes software routines used to control the operation of the switch 100. The switch configuration file 108 includes configuration information utilized by the switch OS 106. For example, the switch configuration file 108 may include selection criteria or selection parameters for packet mirroring.

In accordance with an embodiment of the invention, the switch OS 106 is configured with a mirroring module or engine 110. The mirroring module 110 is configured to extract selected portions of a network packet to create a data value. The data value may be passed to a comparator system 114.

In accordance with one embodiment, the comparator system 114 may comprise, for example, a content addressable memory (CAM) system. Various forms of content addressable memory may be utilized. For example, the CAM may be of a binary or ternary type. Binary CAMs store and compare binary bits that may be either true or false (i.e. 1 or 0). Ternary CAMs store and compare bits that may be either true or false or “do not care” (i.e. 1 or 0 or X). In accordance with other embodiments, the comparator system may comprise a Hash table, a range look-up, or another comparator system.

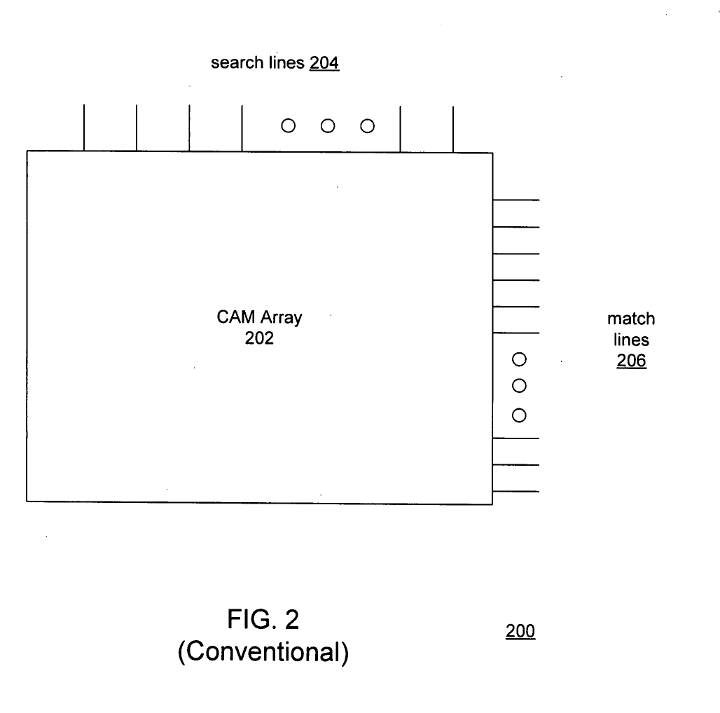

An illustrative CAM configuration 200 is depicted in FIG. 2. Cells within a CAM array 202 may be arranged into word rows that may be matched or not matched by a look-up (search) word. The data value may be broadcast to rows of words via search lines 204, and an indication of whether the data value matches a word stored at a particular row may indicated by a signal on a match line 206 corresponding to the particular row.

If the data value matches one or more entries in the comparator system 114, then a query may be made to a sampling module 112 to determine if the packet being processed is chosen to be sampled. The sampling module 112 may be implemented with hardware circuitry and/or software code executed using a processor. The sampling module 112 may be configured to return a signal indicating whether or not a particular packet should be or is to be sampled.

The sampling module 112 may utilize a sampling technique pre-selected to determine which packets to sample. In one embodiment, the sampling technique may utilize a random selection mechanism where a probability that a packet is selected is configurable or adjustable. In other embodiments, the sampling technique may be based on a non-random selection mechanism.

In one embodiment, the fraction or percentage of packets selected by the sampling technique may be configured by a user so as to avoid overflowing an input buffer of the monitoring device. In another embodiment, a feedback signal from the monitoring device may be utilized by the sampling module to adjust the fraction or percentage of packets selected so as to prevent overflowing the monitoring device.

In one embodiment, different entries in the comparator system 114 may point to different sampling modules, each configurable to have a different probability of sampling. Alternatively or in addition, the apparatus may be configured such that several different entries in the comparator system 114 point to the same sampling module. This may advantageously save sampling resources or to group packets of a given class together.

Those data packets which both match an entry in the comparator system 114 and are selected for sampling by the sampling module 112 are sent to a monitoring (mirror) port, in addition to being sent to the appropriate destination port.

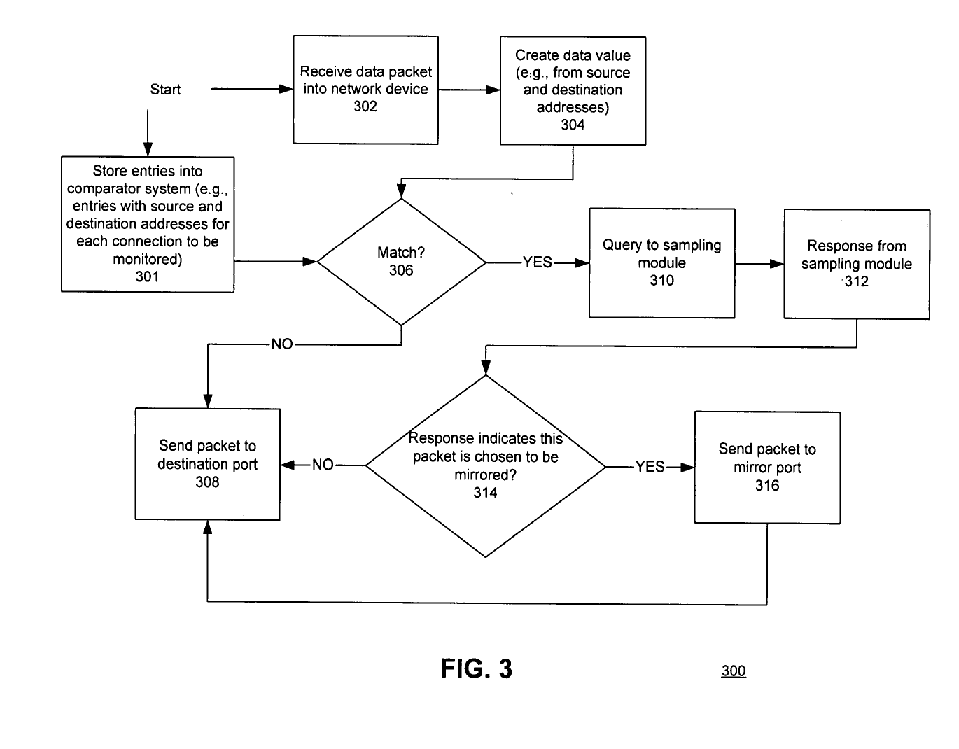

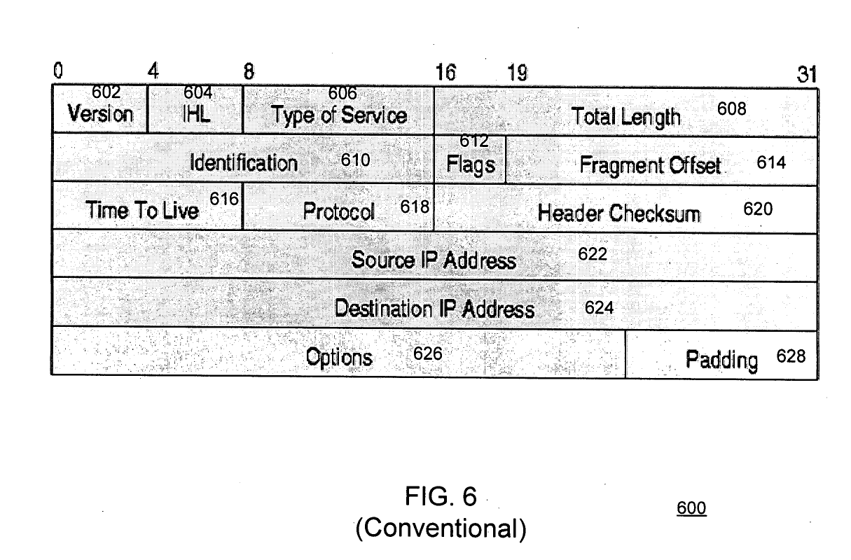

FIG. 3 is a flow chart depicting a method 300 of monitoring network traffic in accordance with an embodiment of the invention. The method 300 includes storing 301 entries into a comparator system 114. For example, the entries may include a source IP address 622 and a destination IP address 624 of each IP connection to be monitored. (See FIG. 6, discussed below.)

A data packet is received 302 into the network device. The network device may comprise, for example, a networking switch 100 as described above in relation to FIG. 1, or may comprise an alternative networking device, such as a router, or hub, or similar device.

For each packet received, a data value (e.g., a look-up word) is created 304 from selected fields of the data packet. The selected fields comprise different portions of the packet to be examined so that those packets of interest are selected. Multiple fields may be selected, and the information therein may be combined, so as to create 304 the data value. For example, the selected fields include the source IP address field 622 and the destination IP address field 624 in the IP header 600. (See FIG. 6, discussed below.)

A determination 306 may be then made as to whether the data value matches one or more entries in a comparator system 114. As discussed above, the comparator system 114 is configured to store data values representing criteria for selecting packets of interest that are to be sampled.

If there is no match (i.e. the packet is not of a type of interest), then the packet is simply sent (switched) 308 to the appropriate destination port. The destination port being determined, for example, based on a destination address in the packet, as is known to those of skill in the art.

On the other hand, if a match is found (i.e. the packet is of a type of interest), then a determination may be made as to whether this specific packet is to be mirrored (sent to the monitoring device). This determination may be accomplished by sending a query 310 to a sampling module, and receiving a response 312 from the sampling module. In one embodiment, the sampling module may comprise a sampling module 112 that responds with a choice of whether a specific packet is to be mirrored.

If the response from the sampling module indicates 314 that the specific packet is not chosen to be mirrored, then the packet is simply sent (switched) 308 to the appropriate destination port. On the other hand, if the sampling module indicates 314 that the specific packet is chosen to be mirrored, then a copy of the packet is sent 316 to a pre-designated mirror (or monitor) port of the networking device. In addition, the packet is also sent (switched) 308 to the appropriate destination port.

For example, searching using a data value created 304 from the source/destination IP address pair 622/624 of a received packet may be performed to select 306 only those packets associated with the stored pairs of source/destination IP addresses 622/624. Some of those selected packets may then be chosen 314 to be mirrored. In this example, the method 300 provides for monitoring of specified point-to-point connections in an IP network while advantageously limiting the amount of sampled data in a well distributed (randomly distributed) manner.

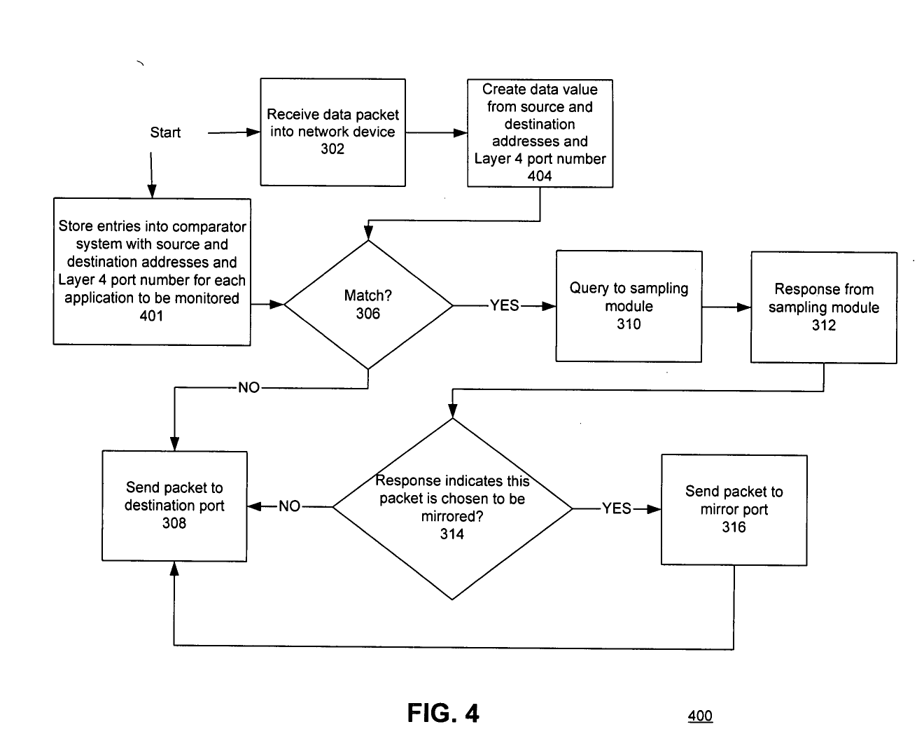

FIG. 4 is a flow chart depicting a method 400 of monitoring traffic relating to specific applications in accordance with an embodiment of the invention. The method 400 of FIG. 4 is similar to the method 300 of FIG. 3, but the method 400 of FIG. 4 relates in particular to monitoring specific applications over IP connections.

In this case, in addition to storing IP (network layer 3) source and destination addresses, a network layer 4 port number is stored 401 in the comparator system entry. The layer 4 port number corresponds to a particular application to be monitored on that point-to-point IP connection.

Furthermore, the data value created 404 includes not only the IP (layer 3) source and destination address fields, but also the layer 4 port number of a packet. This enables the appropriate search in the comparator system 114 to find packets with both layer 3 and layer 4 information that matches 306 one or more of the comparator system entries.

The searching using a data value created 404 from the source/destination IP addresses 622/624 and the layer 4 port number of a received packet is performed to select 306 only those packets associated with specified applications communicating over specified point-to-point IP connections. Some of those selected packets may then be chosen 314 to be mirrored. Hence, this method 400 provides for monitoring of specified applications while advantageously limiting the amount of sampled data in a well distributed (randomly distributed) manner.

In one embodiment, a ternary comparator system may be used to provide monitoring of network traffic associated with both point-to-point IP connections per FIG. 3 and specific applications over IP connections per FIG. 4. In that case, a comparator system entry for a point-to-point connection may have a “do not care” in the layer 4 port number field.

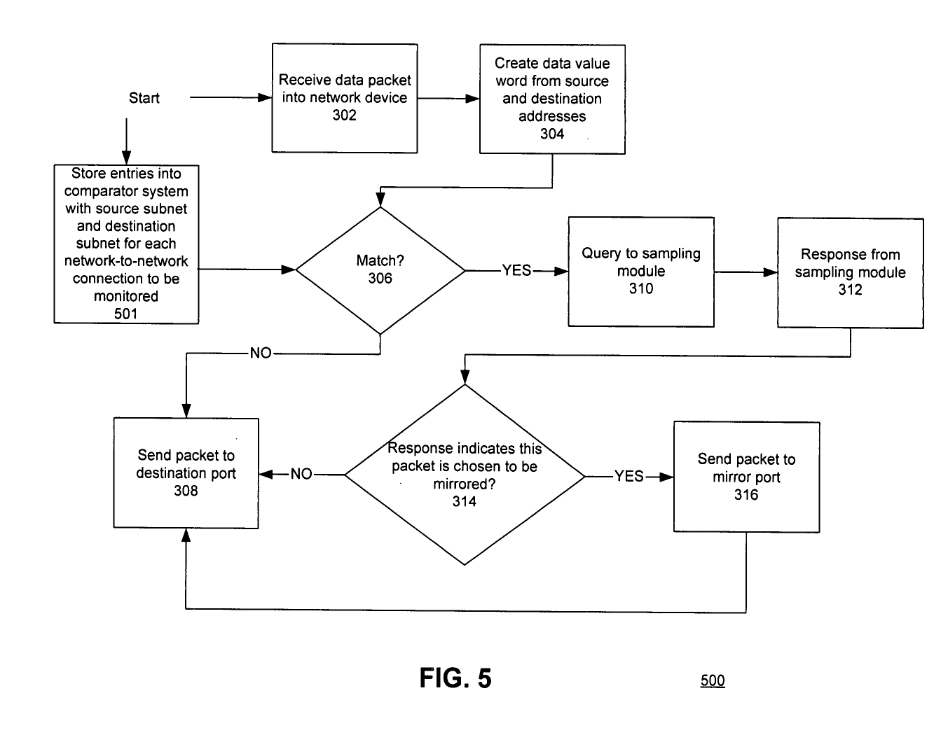

FIG. 5 is a flow chart depicting a method 500 of monitoring specific network-to-network connections in accordance with an embodiment of the invention. The method 500 of FIG. 5 is similar to the method 300 of FIG. 3, but the method 500 of FIG. 5 relates in particular to monitoring connections between a pair of IP subnets.

In this case, source and destination IP subnets are stored 501 in the comparator system entry. IP subnets are subsets of IP address space. For example, an IP subnet may include IP addresses of a specific local or wide area network.

The comparator system 114 with stored IP subnets is utilized to select 306 only those packets being communicated between a first subnet and a second subnet. Some of those selected packets may then be chosen 314 to be mirrored. Hence, this method 500 provides a way to monitor packets transmitted between two networks (each network having its own IP subnet).

In one embodiment, a ternary CAM may be used to provide monitoring of network traffic associated with both point-to-point IP connections per FIG. 3 and subnet-to-subnet IP connections per FIG. 5. In that case, a CAM entry for a subnet-to-subnet connection may have “do not care” states for the masked portions of the subnet addresses. In addition, point-to-subnet and subnet-to-point traffic may be similarly monitored by using “do not care” states for the masked portions of the subnet addresses. Furthermore, network traffic associated with specific applications may be selectable by having a layer 4 port number field in the CAM entries.

FIG. 6 is a diagram depicting fields of a conventional IP header 600. The IP header 600 includes various fields, such as a version field 602, an Internet header length (IHL) 604, a type of service 606, a total length 608, an identification field 610, a flags field 612, a fragment offset 614, a time to live (TTL) 616, a protocol field 618, a header checksum 620, a source IP address 622, a destination IP address 624, options 626, and padding 628. As discussed above, data from the source IP address 622 and the destination IP address 624 may be extracted so as to form a data value to select packets of interest for sampling.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of monitoring network traffic, the method comprising:
receiving a network data packet;
extracting network address information from the network data packet and creating a data value therefrom;
comparing the data value with a set of predetermined network address information; and
if a match is found, determining based on a preselected sampling technique whether said network data packet is to be mirrored.

2. The method of claim 1, wherein the network address information includes a source address.

3. The method of claim 2, wherein the network address information further includes a destination address.

4. The method of claim 3, wherein the network address information further includes a layer 4 port number.

5. The method of claim 1, wherein the set of predetermined network address information includes source and destination IP addresses for each point-to-point IP (Internet Protocol) connection to be monitored.

6. The method of claim 5, wherein the set of predetermined network address information further includes a layer 4 port number for each application to be specifically monitored.

7. The method of claim 6, wherein the layer 4 port number in the set of predetermined network address information is a “do not care” value if the IP connection is to be monitored regardless of the application.

8. The method of claim 1, wherein the set of predetermined network address information includes source and destination IP (Internet Protocol) subnets for each network-to-network IP connection being monitored.

9. The method of claim 8, wherein “do not care” values are used for masked IP address bits in the subnets.

10. The method of claim 1, further comprising:
sending the network data packet to a destination port; and
if said network data packet is determined to be mirrored, then sending the network data packet to a mirror port.

11. A networking device comprising:
a plurality of ports configured to receive and transmit network packets;
a comparator coupled to the ports which is configured to indicate whether address information contained in a network packet finds a match in a set of predetermined address information; and
a sampling module, responsive to the match indication, to determine based on a preselected sampling technique whether the network packet is to be mirrored.

12. The networking device of claim 11, wherein the address information includes a source address.

13. The networking device of claim 12, wherein the address information further includes a destination address.

14. The networking device of claim 13, wherein the address information further includes a layer 4 port number.

15. The networking device of claim 11 wherein the set of predetermined address information includes source and destination IP (Internet Protocol) addresses for each point-to-point IP connection to be monitored.

16. The networking device of claim 15, wherein the set of predetermined address information further includes a layer 4 port number for each application to be specifically monitored.

17. The networking device of claim 16, wherein the layer 4 port number is a “do not care” value if the IP connection is to be monitored regardless of the application.

18. The networking device of claim 11, wherein the set of predetermined address information includes source and destination IP (Internet Protocol) subnets for each network-to-network IP connection being monitored.

19. The networking device of claim 18, wherein “do not care” values are used for masked IP address bits in the subnets.

20. The networking device of claim 11, further comprising a mirroring module which is further configured to send the network packet to a destination port, and to send the network packet to a mirror port if a response from the sampling module indicates that the network packet is to be mirrored.

21. The networking device of claim 21, wherein the sampling module uses a random selection mechanism.

22. A network monitoring system, comprising:
means for receiving a network data packet;
means for extracting network address information from the network data packet and creating a data value therefrom;
means for comparing the data value with a set of predetermined network address information; and
means for determining, if a match is found, whether said network data packet is to be mirrored based on a preselected sampling technique.
